(19) United States
(12) Patent Application Publication
(10) Pub. No.: US 2021/0370230 A1
(43) Pub. Date: Dec. 2, 2021

(54) ENHANCED SORBENT MEMBRANE FOR CARBON DIOXIDE CAPTURE AND METHOD FOR SAME

(71) Applicant: ARIZONA BOARD OF REGENTS ON BEHALF OF ARIZONA STATE UNIVERSITY, Scottsdale, AZ (US)

(72) Inventors: Allen Wright, Gilbert, AZ (US); Klaus Lackner, Paradise Valley, AZ (US)

(21) Appl. No.: 17/287,982

(22) PCT Filed: Oct. 28, 2019
(86) PCT No.: PCT/US2019/058409

§ 371 Date: Apr. 22, 2021

Related U.S. Application Data
(60) Provisional application No. 62/752,725, filed on Oct. 30, 2018.

(51) Int. Cl. B01D 53/22; B01J 20/285; B01J 20/32

(52) U.S. Cl. CPC B01D 53/228; B01J 20/285; B01J 20/3276; B01J 20/3272; B01J 20/328; B01D 2257/504; B01D 2325/20; B01D 2325/38; B01D 2325/42; B01D 2323/04; B01J 20/3285

(57) ABSTRACT

A method for enhancing a sorbent membrane for carbon dioxide capture is disclosed. The method includes applying a layer of a hydrophobic material to at least one surface of the sorbent membrane. The hydrophobic material may be one of a polysioxane, a silicone compound, and a fluoroacrylic copolymer. The sorbent membrane may be an anionic exchange membrane, and may have a quaternary ammonium functional group. The layer of hydrophobic material reduces the amount of water used in the carbon dioxide capture process, and relaxes the water quality constraints.

### RELATED APPLICATIONS

This application claims the benefit of and priority to U.S. provisional patent application 62/752,725, filed Oct. 30, 2018, the entirety of the disclosure of which is hereby incorporated by this reference.

### STATEMENT REGARDING FEDERALLY SPONSORED RESEARCH

This invention was made with government support under DE-EE0007093 awarded by the Department of Energy. The government has certain rights in the invention.

### TECHNICAL FIELD

Aspects of this document relate generally to sorbent membranes for carbon dioxide capture.

### BACKGROUND

The need for energy efficient, inexpensive, and scalable technologies to remove carbon dioxide from ambient air has been well established. A novel response to this need is the development of direct air capture devices that passively capture atmospheric carbon dioxide from natural airflow. Some of these devices make use of sorbent materials sensitive to a humidity or moisture swing, capturing carbon dioxide in low humidity and releasing it upon exposure to increased humidity.

Typically, moisture-swing based carbon dioxide capture systems make use of readily available water sources. In some circumstances, such as when operating at a remote location limited to local ground water, the water used to release the captured carbon dioxide may contain contaminating ions, such as chloride, in sufficient concentration to impact the efficiency of the sorbent. In some cases, these contaminants effectively halted carbon dioxide capture.

An additional limitation of systems based on moisture-swing sorbents is the transition between release (wet) and capture (dry) phases, which requires the evaporation of water from the sorbent. The consumption of water has a large impact on the economics of the CO2 capture process.

### SUMMARY

According to one aspect, a method for enhancing a sorbent membrane for carbon dioxide capture includes applying a hydrophobic material to at least one surface of the sorbent membrane. Particular embodiments may comprise one or more of the following features. The hydrophobic material may include one of a polysioxane and a silicone compound. The hydrophobic material may include a hydroxy-terminated polydimethylsiloxane. The hydrophobic material may include a fluoroacrylic copolymer. The sorbent membrane may be an anionic exchange membrane. The sorbent membrane may include a quaternary ammonium functional group. The sorbent membrane may be a heterogeneous ion exchange membrane. Applying the hydrophobic material may include spraying the hydrophobic material on the at least one surface of the sorbent membrane. Applying the hydrophobic material may include painting the hydrophobic material on the at least one surface of the sorbent membrane. The hydrophobic material may be applied to all surfaces of the sorbent membrane.

According to another aspect of the disclosure, an enhanced membrane for carbon dioxide capture includes a sorbent membrane having a plurality of surfaces. At least one surface of the plurality of surfaces includes a layer of hydrophobic material deposed on at least one surface of the sorbent membrane. Particular embodiments may comprise one or more of the following features. The hydrophobic material may include one of a polysioxane and a silicone compound. The hydrophobic material may include a hydroxy-terminated polydimethylsiloxane. The hydrophobic material may include a fluoroacrylic copolymer. The sorbent membrane may be an anionic exchange membrane. The sorbent membrane may include a quaternary ammonium functional group. The sorbent membrane may be a heterogeneous ion exchange membrane. The layer of hydrophobic material may be an aerosol-deposed layer. The layer of hydrophobic material may be a mechanically-deposed layer. Every surface of the plurality of surfaces may include the layer of hydrophobic material.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1 is a perspective view of an enhanced sorbent membrane.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

The need for energy efficient, inexpensive, and scalable technologies to remove carbon dioxide from ambient air has been well established. A novel response to this need is the development of direct air capture devices that passively capture atmospheric carbon dioxide from natural airflow. Some of these devices make use of sorbent materials sensitive to a humidity or moisture swing, capturing carbon dioxide in low humidity and releasing it upon exposure to increased humidity.

Typically, moisture-swing based carbon dioxide capture systems make use of readily available water sources. In some circumstances, such as when operating at a remote location limited to local ground water, the water used to release the captured carbon dioxide may contain contaminating ions, such as chloride, in sufficient concentration to impact the efficiency of the sorbent.

For example, in one instance, the use of local ground water reduced the swing in carbon dioxide concentration within a closed system (cycling between ‘dry’ and ‘humid’ states) from 100 ppm to 30 ppm. In another instance, the application of a concentrated sodium chloride solution essentially stopped all carbon dioxide capture.

An additional limitation of systems based on moisture-swing sorbents occurs in the transition between release (wet) and capture (dry) phases, which requires the evaporation of water from the sorbent. The consumption of water has a large impact on the economics of the CO2 capture process.

Contemplated herein is an enhanced sorbent membrane for carbon dioxide capture, and method for creating the same. A sorbent membrane is enhanced by treating it with a layer of hydrophobic material, resulting in a reduction in the amount of water consumed and an increased capacity to withstand contaminants, thereby relaxing the water quality constraints. These enhanced sorbent membranes are better able to resist contamination, and are more efficient in water use, than conventional sorbent membranes.

Land with ready access to a clean water supply, such as a municipal water supply, tends to be more expensive than land that is limited to a ground water supply. Given the extremely thin economic margins of carbon dioxide capture and repurposing, as well as the scale on which CO2 capture needs to occur to have the desired environmental effect, the cost of land and/or water is a factor that cannot be ignored. The enhanced sorbent membranes contemplated herein may facilitate the deployment of carbon dioxide capture systems in locations that would otherwise be unsuitable due to the nature of the available water, potentially making the endeavor more economically feasible.

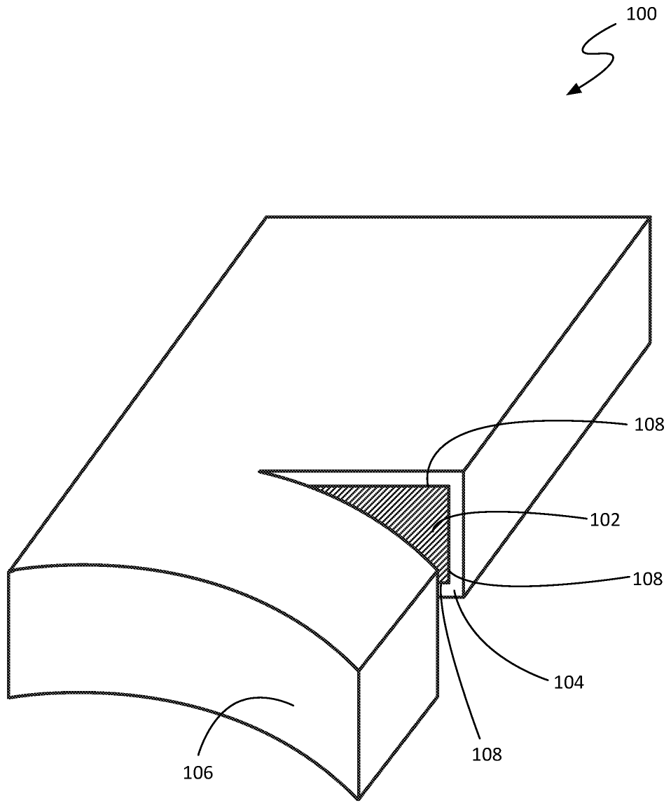

FIG. 1 is a perspective view of a non-limiting example of an enhanced sorbent membrane 100. As shown, the enhanced sorbent membrane 100 comprises a sorbent membrane 102 having a plurality of surfaces 108, and a layer 104 of hydrophobic material 106 coupled to at least one surface 108 of the membrane 102. It should be noted that the enhanced membrane 100 has been partially sliced, and the thickness of the layer 104 exaggerated, for illustrative purposes.

According to various embodiments, the hydrophobic layer 104 serves to protect the functional groups of the sorbent membrane 102 from ionic contaminants present in the water used in the moisture swing process of capturing and releasing carbon dioxide. The layer 104 of hydrophobic material 106 also reduces the amount of entrained water carried by the wet membrane (post release) that must be evaporated away in the capture side of the process.

In the context of the present description and the claims that follow, to say that the layer 104 of hydrophobic material 106 is coupled to a surface 108 of the sorbent membrane 102 is in no way meant to imply an order in which the sorbent membrane 102 and the layer 104 of hydrophobic material 106 are formed, nor whether the layer 104 existed before being coupled to a surface 108 of the membrane 102.

As will be discussed in greater detail, below, in some embodiments the layer 104 may be formed (e.g. deposed, applied, distributed, spread, etc.) directly on a surface 108 of the membrane 102, while in other embodiments the layer 104 may be formed and then subsequently coupled (e.g. adhered, bonded, etc.) to the surface 108 of the membrane 102. In still other embodiments, the layer 104 and membrane 102 may be formed contemporaneously.

According to various embodiments, at least one surface 108 of the plurality of surfaces 108 of the sorbent membrane 102 is covered with a layer 104 of hydrophobic material 106. In some embodiments, a layer 104 may be on more than one surface 108. For example, as shown in FIG. 1, in some embodiments, every surface 108 of the sorbent membrane 102 may be covered with a layer 104 of hydrophobic material 106.

In the context of the present description and the claims that follow, a sorbent membrane 102 is a selective barrier that allows some things to pass through while stopping others, while also capturing specific things. It should be noted that while the following discussion is done in the context of sorbent membranes 102 that capture carbon dioxide, those skilled in the art will recognize that the enhancement methods contemplated herein may be advantageously applied to moisture-swing sorbent membranes that capture other compounds or materials.

Membranes that selectively allow diffusion and adsorption of ions while excluding certain other ions and non-ionized compounds are typically referred to as ion exchange membranes. According to various embodiments, the sorbent membrane 102 inside the enhanced sorbent membrane 100 is an anionic exchange membrane. As a specific example, in some embodiments, the sorbent membrane 102 may be an anionic exchange membrane having a quaternary ammonium functional group.

There are two main types of ion exchange membranes, homogeneous membranes and heterogeneous membranes. In the context of the present description and the claims that follow, a homogeneous ion exchange membrane is one whose entire volume, discounting any support structure or material, is made from a reactive polymer. Exemplary homogeneous membranes include, but are not limited to, membranes made of sulfonated or aminated styrene-divinylenzene polymers, polymerized perfluorosulfonic acids, thermoplastics with active groups grafted onto the polymer base, and the like.

In some embodiments, the sorbent membrane 102 is a heterogeneous ion exchange membrane. In the context of the present description and the claims that follow, a heterogeneous ion exchange membrane is a membrane comprising an ion exchange resin (for electrochemical properties), and a binder material (for physical strength). As a specific example, in one embodiment, the ion exchange resin may be in a hydrophilic composite, and the binder may be a hydrophobic polymer. Exemplary binders include, but are not limited to, polypropylene, polyolefins, low density polyethylene, a thermoplastic, an elastomer, and the like. Heterogeneous membranes are typically easier to manufacture and are mechanically stronger than homogeneous membranes.

As a specific example, in some embodiments, the sorbent membrane 102 may be a heterogeneous anionic exchange membrane composed of a crushed anionic exchange resin mixed in a polypropylene matrix. Such a material is commercially available from Snowpure, LLC, San Clemente, Calif., and is disclosed in the teachings of U.S. Pat. Nos. 6,503,957 and 6,716,888.

According to various embodiments, the hydrophobic material 106 is a hydrophobic polymer or copolymer. Examples include, but are not limited to, a fluoroacrylic copolymer, a silicone compound, polysioxane, hydroxy-terminated polydimethylsiloxane, and the like. In one specific embodiment, the hydrophobic material 106 is a commercially available hydroxy-terminated polydimethylsiloxane treatment called Rain-X, from Illinois Tool Works. In another specific embodiment, the hydrophobic material 106 is a commercially available fluoroacrylic copolymer treatment called FluoroPel Membranes 7, from Cytonix Co.

The layer 104 of hydrophobic material 106 is thinner than the sorbent membrane 102 to which it is coupled. In some embodiments, the hydrophobic layer 104 is at least an order of magnitude thinner than the sorbent membrane 102. In other embodiments, the hydrophobic layer 104 may be less than an order of magnitude thinner than the sorbent membrane 102. As a specific example, in one embodiment, the sorbent membrane 102 is approximately 1 mm thick, while the hydrophobic layer 104 may be at least 0.1 mm thick.

Just as different embodiments of the enhanced membrane 100 may include different sorbent membranes 102 and/or use different hydrophobic materials 106, the layer 104 may be formed or applied in various ways. Additionally, in some embodiments, the layer 104 may be applied to a surface 108 of the sorbent membrane 102 as a single coating or application, while in other embodiments the layer 104 may be formed through repeated, stacked applications of the hydrophobic material 106.

In some embodiments, applying the hydrophobic material 106 on the surface 108 of the membrane 102 comprises spraying or otherwise broadcasting the material 106 through the air to impact the surface 108. The droplet size may vary from one embodiment to another. In some embodiments the material 106 may be applied using a conventional spray bottle with a squeeze trigger. In other embodiments, the material 106 may be deposed as a layer 104 through a gas-driven aerosol mist. In still other embodiments, the hydrophobic material 106 may be applied to the surface 108 as a fog. Additional embodiments may employ any other tool or technique known in the art for broadcast application of a liquid material to a surface.

Just as different embodiments of the enhanced membrane 100 may include different sorbent membranes 102 and/or use different hydrophobic materials 106, the layer 104 may be formed or applied in various ways. Additionally, in some embodiments, the layer 104 may be applied to a surface 108 of the sorbent membrane 102 as a single coating or application, while in other embodiments the layer 104 may be formed through repeated, stacked applications of the hydrophobic material 106.

In some embodiments, applying the hydrophobic material 106 on the surface 108 of the membrane 102 comprises spraying or otherwise broadcasting the material 106 through the air to impact the surface 108. The droplet size may vary from one embodiment to another. In some embodiments the material 106 may be applied using a conventional spray bottle with a squeeze trigger. In other embodiments, the material 106 may be deposed as a layer 104 through a gas-driven aerosol mist. In still other embodiments, the hydrophobic material 106 may be applied to the surface 108 as a fog. Additional embodiments may employ any other tool or technique known in the art for broadcast application of a liquid material as a thin film or coating on a surface.

In some embodiments, applying the hydrophobic material 106 to the surface 108 of the membrane 102 comprises delivery and/or manipulation of the material 106 on the surface 108 though direct contact. Such layers may also be referred to as mechanically-deposed layers. For example, in one embodiment, the hydrophobic material 106 is applied to the surface 108 by painting it on using an implement. Exemplary implements include, but are not limited to, brushes, sponges, swabs, rollers, stamps, wipes, spreaders, spatulas, and the like. Other embodiments may employ any other tool or technique known in the art for mechanical application of a material as a thin film or coating on a surface.

Other embodiments may apply the hydrophobic material 106 to form a layer 104 on at least one surface 108 of the membrane using other methods or techniques. Examples include, but are not limited to, dipping, spin deposition, vapor condensation, thermal bonding of a pre-formed hydrophobic layer, and the like. In some embodiments, the layer 104 and the membrane 102 may be formed contemporaneously. As a specific example, in one embodiment, the sorbent membrane 102 may be formed through thermal extrusion, and the layer 104 may be applied and extruded along with the membrane 102 at the time of manufacture.

### Exemplary Results—Water Retention

Untreated samples of Snowpure Excellion 1-200 anionic exchange membrane were weighed both in the “dry” state and after immersion in deionized water, the “wet” state. The same samples were treated with either a sprayed application of Rain-X (i.e. hydroxy-terminated polydimethylsiloxane) or a painted application of FluoroPel Membranes 7 (i.e. a fluoroacrylic copolymer).

Immersion in deionized water (i.e. transitioning from the dry state to the wet state) caused the untreated samples to undergo a 48.4% and 44.6% mass gain, respectively. The first sample, after the Rain-X treatment, experienced a 31.7% mass gain, a 34.5% reduction in water retention. The second sample, after the FluoroPel treatment, saw a 5.7% mass gain, a 97.5% reduction in water retention.

### Exemplary Results—Contamination

As discussed above, the contamination of the active sites of the ion exchange sorbents used in the moisture swing process of the direct air capture of carbon dioxide by negative ions in the environment can markedly decrease the capacity of the sorbent over time. Table 1, below, shows that the application of hydrophobic materials 106 such as Rain-X and FluoroPel Membranes 7, can shield the active exchange sites of the sorbent and preserve their function in the presence of contaminating ions.

The measurements of Table 1 were made using a closed system within which humidity is controlled and the concentration of carbon dioxide in the atmosphere of the closed system is measured. The humidity was “swung” back and forth between 30 minute “dry” and 30 minute “humid” periods, and the change in the concentration of carbon dioxide was observed. As the humidity rises, the sorbent will give off carbon dioxide as it adsorbs water vapor and conversely, as the humidity drops, the sorbent will adsorb carbon dioxide as it gives off water vapor.

TABLE 1

| | | Change |
|---|---|---|
| | | in CO₂ |
| | | concen- |
| | | tration |
| | | (parts per |
| # | Sample Description | million) |
| 1 | Empty system (blank, null run) | 8 |
| 2 | Virgin unused sorbent material | 100 |
| 3 | Virgin unused sorbent material washed in 1M NaCl | 10 |
| | solution to contaminate, or poison the sorbent | |
| 4 | Sample from device in the field after exposure to | 30 |
| | ground water | |
| 5 | Sample from device in the field having been washed in | 100 |
| | a solution of sodium carbonate | |
| 6 | Virgin sample treated with FluoroPel Membranes 7 | 50 |
| 7 | Virgin sample treated with FluoroPel Membranes 7 and | 50 |
| | washed in 1M NaCl solution to contaminate or poison | |
| | the sorbent | |
| 8 | Virgin sample treated with rain-x ™ | 90 |
| 9 | Virgin sample treated with rain-x ™ and washed in 1M | 10 |
| | solution of NaCl to contaminate or poison the sorbent | |

As shown, a virgin sample achieved a swing in carbon dioxide concentration of 100 ppm. The same sample size, after being exposed to periodic soakings in ground water, showed a reduced swing to 30 ppm. That sample, after being washed in a sodium carbonate solution, regained its original swing of 100 ppm, demonstrating the deleterious effect that exposure to ground water salts will have on sorbent performance.

Furthermore, a virgin sample washed in a strong 1M solution of sodium chloride lost almost all ability to capture carbon dioxide

However, an identical sample treated with FluoroPel Membranes 7, while losing some capture capacity, showed no effect of having been washed in the 1M sodium chloride solution. The Rain-X treatment, while retaining a greater percentage of original performance, was severely affected by the sodium chloride wash.

Where the above examples, embodiments and implementations reference examples, it should be understood by those of ordinary skill in the art that other sorbent membranes and hydrophobic materials could be intermixed or substituted with those provided. In places where the description above refers to particular embodiments of enhanced sorbent membranes for carbon dioxide capture and enhancement methods, it should be readily apparent that a number of modifications may be made without departing from the spirit thereof and that these embodiments and implementations may be applied to other sorbent materials as well. Accordingly, the disclosed subject matter is intended to embrace all such alterations, modifications and variations that fall within the spirit and scope of the disclosure and the knowledge of one of ordinary skill in the art.

1. A method for enhancing a sorbent membrane for carbon dioxide capture, comprising applying a hydrophobic material to at least one surface of the sorbent membrane.

2. The method of claim 1, wherein the hydrophobic material comprises one of a polysiloxane and a silicone compound.

3. The method of claim 2, wherein the hydrophobic material comprises a hydroxy-terminated polydimethylsiloxane.

4. The method of claim 1, wherein the hydrophobic material comprises a fluoroacrylic copolymer.

5. The method of claim 1, wherein the sorbent membrane is an anionic exchange membrane.

6. The method of claim 5, wherein the sorbent membrane comprises a quaternary ammonium functional group.

7. The method of claim 5, wherein the sorbent membrane is a heterogeneous ion exchange membrane.

8. The method of claim 1, wherein applying the hydrophobic material comprises spraying the hydrophobic material on the at least one surface of the sorbent membrane.

9. The method of claim 1, wherein applying the hydrophobic material comprises painting the hydrophobic material on the at least one surface of the sorbent membrane.

10. The method of claim 1, wherein the hydrophobic material is applied to all surfaces of the sorbent membrane.

11. An enhanced membrane for carbon dioxide capture, comprising: a sorbent membrane having a plurality of surfaces, wherein at least one surface of the plurality of surfaces comprises a layer of hydrophobic material deposed on at least one surface of the sorbent membrane.

12. The enhanced membrane of claim 11, wherein the hydrophobic material comprises one of a polysiloxane and a silicone compound.

13. The enhanced membrane of claim 12, wherein the hydrophobic material comprises a hydroxy-terminated polydimethylsiloxane.

14. The enhanced membrane of claim 11, wherein the hydrophobic material comprises a fluoroacrylic copolymer.

15. The enhanced membrane of claim 11, wherein the sorbent membrane is an anionic exchange membrane.

16. The enhanced membrane of claim 15, wherein the sorbent membrane comprises a quaternary ammonium functional group.

17. The enhanced membrane of claim 15, wherein the sorbent membrane is a heterogeneous ion exchange membrane.

18. The membrane of claim 11, wherein the layer of hydrophobic material is an aerosol-deposed layer.

19. The membrane of claim 11, wherein the layer of hydrophobic material is a mechanically-deposed layer.

20. The membrane of claim 11, wherein every surface of the plurality of surfaces comprises the layer of hydrophobic material.
